(19) United States
(12) Patent Application Publication
(10) Pub. No.: US 2026/0066475 A1
(43) Pub. Date: Mar. 5, 2026

(54) IMPROVED STRENGTH MICROPOROUS MEMBRANES, SEPARATOR MEMBRANES, BASE FILMS, AND BATTERY SEPARATORS

(71) Applicant: CELGARD, LLC, Charlotte, NC (US)

(72) Inventors: Yue Ma, Charlotte, NC (US); Changqing Wang Adams, Fort Mill, SC (US); William J. Mason, McConnells, SC (US)

(21) Appl. No.: 19/319,185

(22) Filed: Sep. 4, 2025

Related U.S. Application Data
(60) Provisional application No. 63/690,661, filed on Sep. 4, 2024.

(51) Int. Cl. H01M 50/494; B01D 69/12; B01D 71/26; H01M 8/0239; H01M 8/0245; H01M 50/417; H01M 50/449; H01M 50/491

(52) U.S. Cl. CPC H01M 50/494; B01D 69/12; B01D 71/262; H01M 8/0239; H01M 8/0245; H01M 50/417; H01M 50/449; H01M 50/491; B01D 2325/02834; B01D 2325/04; B01D 2325/06; B01D 2325/22; B01D 2325/24; B01D 2325/52

(57) ABSTRACT

An improved strength microporous membrane is described herein. The microporous membrane may be useful as a battery separator, separator membrane, base film, or membrane with a variety of uses thereof. The improved microporous membranes described herein may be dry process polyolefin membranes and may be used as battery separators or as a component of a composite or battery separator. The battery separators or composites may be used in energy storage devices including primary batteries, secondary batteries, fuel cells, capacitors, or super capacitors.

### REFERENCE TO RELATED APPLICATIONS

This application claims the benefit of U.S. provisional patent application Ser. No. 63/690,661 filed Sep. 4, 2024, which is fully incorporated by reference herein.

### FIELD

This application is directed to improved strength microporous membranes, separator membranes, base films, battery separators, and to a variety of related methods and uses thereof. The improved strength microporous membranes described herein may be dry process polyolefin membranes and may be used as battery separators or as a component of a composite or battery separator. The battery separators or composites may be used in energy storage devices including primary batteries, secondary batteries, fuel cells, capacitors, or super capacitors.

### BACKGROUND

Not every microporous membrane is suitable for use as a battery separator. Basic requirements for a battery separator include, at least, the following: (1) electronically insulating and (2) ionically conductive, e.g., ability to allow for the flow of ions such as Na+, Li+, etc. across the membrane. Regarding (2), wettability of the membrane with the electrolyte to be used in a particular battery is typically a requirement. Additionally, it is preferable that the pores of a microporous membrane being used as a separator are not through-holes. Battery separator manufacturers would typically consider through-holes to be a defect.

Beyond the basics, there are many battery separator properties that are desirable. First, a thin separator (e.g., less than 25 microns) is preferred. Recent market trends prefer a separator that is less than 12 microns. Thinner separators allow battery makers to achieve higher energy density. While it is possible to make separators this thin, they often have issues with one or more of the following: lower puncture strength, high variation in thickness/low thickness uniformity, poor runnability in modern separator or battery equipment, etc.

Thus, improved strength membranes or battery separators that are thin, but are fit for modern batteries and equipment are desirable.

### SUMMARY

In one aspect, an improved strength membrane is described herein. The membrane has a thickness from 1 microns to 50 microns, 2 microns to 25 microns, 4 microns to 12 microns, or 5 microns to 10 microns and exhibits one or more, two or more, three or more, four or more, five or more, or all of the following properties: (1) a puncture strength of 270 gf or more; (2) an MD tensile strength above 2,200 kg/cm²; (3) an increased surface roughness; (4) an average pore size of at least 0.35 microns; (5) an increased DB; (6) a TD tensile strength above 110 kg/cm²; (7) a lower ply to ply adhesion force; (8) a polypropylene blend including 10% to 100% by weight high crystallinity polypropylene; (9) a reduced surface area; and/or (10) a porosity of less than 40%.

In another aspect, object or embodiment, a battery separator for use in energy storage devices such as primary batteries, secondary batteries, or fuel cells is described herein. The battery separator may comprise at least one microporous membrane. The microporous membrane may be a microporous membrane, separator membrane, battery separator, or base film comprising a microporous membrane, wherein the microporous membrane has a thickness from 1 microns to 50 microns, 2 microns to 25 microns, 4 microns to 12 microns, or 5 microns to 10 microns, and exhibits one or more, two or more, three or more, four or more, five or more, or all of the following properties: (1) a puncture strength of 270 gf or more; (2) an MD tensile strength above 2,200 kg/cm²; (3) an increased surface roughness; (4) an average pore size of at least 0.35 microns; (5) an increased DB; (6) a TD tensile strength above 110 kg/cm²; (7) a lower ply to ply adhesion force; (8) a polypropylene blend including 10% to 100% by weight high crystallinity polypropylene; (9) a reduced surface area; and/or (10) a porosity of less than 35%.

The microporous membrane, separator membrane, battery separator, or base film above, wherein the microporous membrane has an MD tensile strength above 2,300 kg/cm², above 2,320 kg/cm², or above 2,340 kg/cm².

The microporous membrane, separator membrane, battery separator, or base film above, wherein the microporous membrane has a porosity below 40% or below 35%.

The microporous membrane, separator membrane, battery separator, or base film above, wherein the microporous membrane is a dry process polyolefin membrane and has a thickness from 5 microns to 10 microns; a puncture strength of 270 gf or more; an MD tensile strength above 2,200 kg/cm²; an increased surface roughness; an average pore size of at least 0.40 microns; an increased DB; a TD tensile strength above 130 kg/cm²; a lower ply to ply adhesion force; a polypropylene blend including 10% to 100% by weight high crystallinity polypropylene; (9) a reduced surface area; and/or (10) a porosity of less than 35% or 45%.

The microporous membrane, separator membrane, battery separator, or base film above, wherein the microporous membrane has one or more layers or plies.

The microporous membrane, separator membrane, battery separator, or base film above, wherein the microporous membrane has at least one outer surface, layer or ply made of a polypropylene blend including up to 100% by weight high crystallinity polypropylene.

The microporous membrane, separator membrane, battery separator, or base film above, wherein the microporous membrane is a dry-process microporous membrane.

The microporous membrane, separator membrane, battery separator, or base film above, wherein the microporous membrane has a melt point above 165° C.

The microporous membrane, separator membrane, battery separator, or base film above, wherein the microporous membrane is coated on one or two sides thereof.

An energy storage device comprising the microporous membrane, separator membrane, battery separator, or base film above, wherein the energy storage device is a primary battery, a secondary battery, or a fuel cell.

In yet another aspect, object or embodiment, a dry process polyolefin microporous membrane has a thickness from 4 microns to 12 microns, and exhibits one or more of the properties: (1) a puncture strength of 290 gf or more; (2) an MD tensile strength above 2,200 kg/cm²; (3) an increased surface roughness; (4) an average pore size of at least 0.35 microns; (5) an increased DB; (6) a TD tensile strength above 110 kg/cm²; (7) a lower ply to ply adhesion force; (8) a polypropylene blend including up to 100% by weight high crystallinity polypropylene; (9) a reduced surface area; and/or (10) a porosity of less than 40%.

In still yet another aspect, object or embodiment, a dry process polypropylene microporous membrane has a thickness from 4 microns to 12 microns, and exhibits one or more of the properties: (1) a puncture strength of 280 gf or more; (2) an MD tensile strength above 2,200 kg/cm²; (3) an increased surface roughness; (4) an average pore size of at least 0.35 microns; (5) an increased DB; (6) a TD tensile strength above 110 kg/cm²; (7) a lower ply to ply adhesion force; (8) a polypropylene blend including up to 100% by weight high crystallinity polypropylene; (9) a reduced surface area; and/or (10) a porosity of less than 45%.

In another aspect, an improved strength membrane is described herein. The membrane has a thickness from 1 microns to 50 microns, 2 microns to 25 microns, 4 microns to 12 microns, or 5 microns to 10 microns and exhibits one or more, two or more, three or more, four or more, five or more, or all of the following properties: (1) a puncture strength of 270 gf or more; (2) an MD tensile strength above 2,200 kg/cm²; (3) an increased surface roughness; (4) an average pore size of at least 0.35 microns; (5) an increased DB; (6) a TD tensile strength above 110 kg/cm²; (7) a lower ply to ply adhesion force; (8) a polypropylene blend including 10% to 100% by weight high crystallinity polypropylene; (9) a reduced surface area; (10) a durable puncture strength over time; and/or (11) a porosity of less than 40%.

An improved strength microporous membrane is described herein. The microporous membrane may be useful as a battery separator, separator membrane, base film, or membrane with a variety of related methods and uses thereof. The improved microporous membranes described herein may be dry process polyolefin membranes and may be used as battery separators or as a component of a composite or battery separator. The battery separators or composites may be used in energy storage devices including primary batteries, secondary batteries, fuel cells, capacitors, or super capacitors.

In some embodiments, the puncture strength of the microporous membrane may be 270 gf or more, 280 gf or more, 290 gf or more, 300 gf or more, or 310 gf or more.

In some embodiments, the microporous membrane may have an MD tensile strength above 2,000 kg/cm², above 2,100 kg/cm², above 2,200 kg/cm², above 2,300 kg/cm², or above 2,340 kg/cm².

In some embodiments, the microporous membrane is a dry-process microporous membrane.

In some embodiments, the microporous membrane is a microporous membrane having a melting point above 165° C.

In some embodiments, the microporous membrane is coated on one or two sides thereof.

In another aspect, an energy storage device comprising the battery separator described herein is described. The energy storage device may be a primary battery, a secondary battery, a fuel cell, a capacitor, or a super capacitor.

### DESCRIPTION OF DRAWINGS

FIG. 1 and FIG. 2 are each Scanning Electron Microscope (SEM) images of the surface of an inventive dry-process polypropylene (PP) microporous membrane.

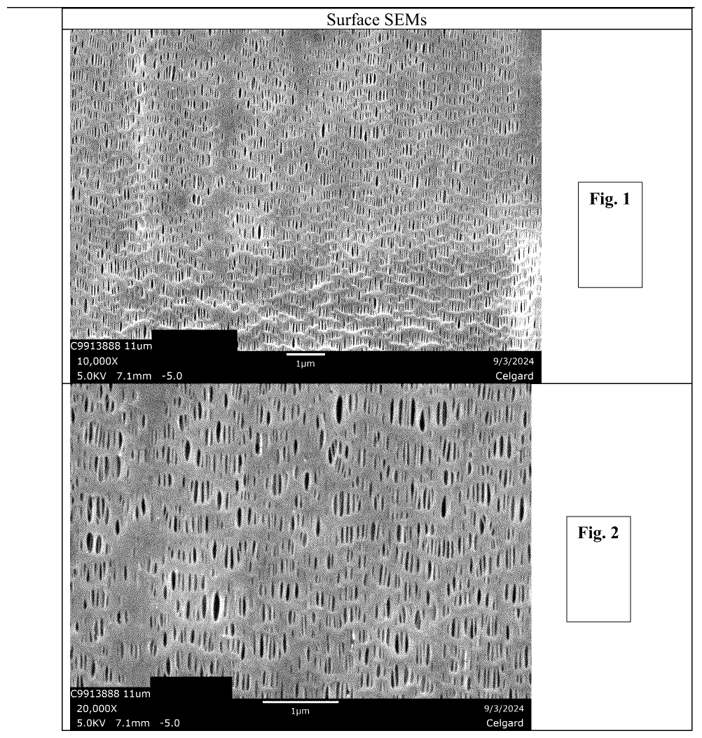

FIG. 3 and FIG. 4 are each Scanning Electron Microscope (SEM) images of the cross section of an inventive dry-process polypropylene (PP) microporous membrane.

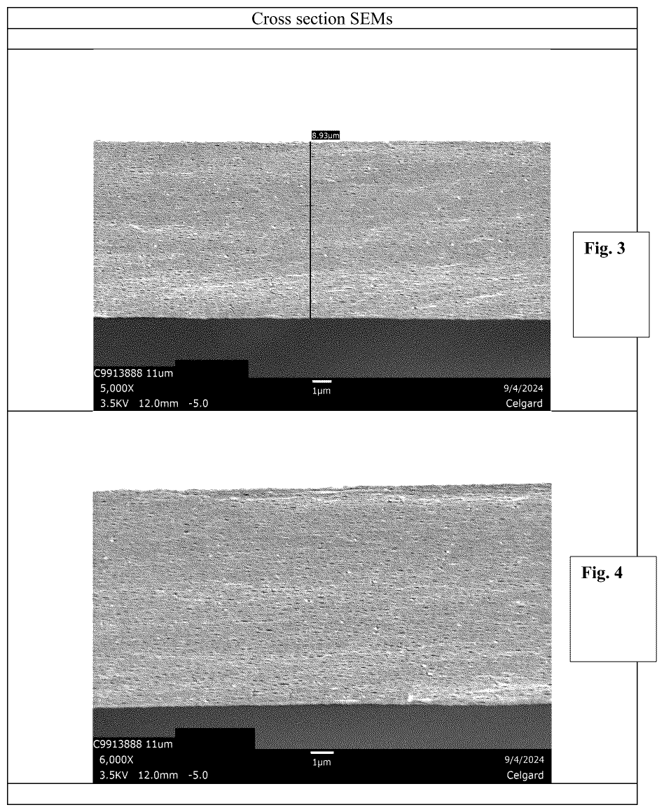

### DETAILED DESCRIPTION

An improved strength microporous membrane is described herein. The improved microporous membrane may be used as a battery separator or as a component of a battery separator. For example, when a battery separator comprises two or membranes, the improved membrane described herein may be at least one of those membranes. The battery separator comprising the improved microporous membranes may be useful in an energy storage device such as a primary battery, a secondary battery, a fuel cell, a capacitor, or a super capacitor. The membrane is described in further detail herein.

### Microporous Membrane

The microporous membranes described herein may have a thickness from 1 microns to 50 microns, from 2 microns to 25 microns, from 4 microns to 12 microns, from 5 microns to 10 microns, from 2 microns to 12 microns, from 2 microns to 11 microns, from 2 microns to 10 microns, from 2 microns to 9 microns, from 2 microns to 8 microns, from 2 microns to 7 microns, from 2 microns to 6 microns, from 2 microns to 5 microns, from 2 microns to 4 microns, or from 2 microns to 13 microns.

The microporous membrane may exhibit one or more, two or more, three or more, four or more, five or more, or all of the following properties: (1) a puncture strength of 270 gf or more; (2) an MD tensile strength above 2,200 kg/cm²; (3) an increased surface roughness; (4) an average pore size of at least 0.35 microns; (5) an increased DB; (6) a TD tensile strength above 110 kg/cm²; (7) a lower ply to ply adhesion force; (8) a polypropylene blend including 10% to 100% by weight high crystallinity polypropylene; (9) a reduced surface area; and/or (10) a thickness of less than 12 microns.

In one aspect, an improved strength membrane is described herein. The membrane has a thickness from 1 microns to 50 microns, 2 microns to 25 microns, 4 microns to 12 microns, or 5 microns to 10 microns and exhibits one or more, two or more, three or more, four or more, five or more, or all of the following properties: (1) a puncture strength of 270 gf or more; (2) an MD tensile strength above 2,200 kg/cm²; (3) an increased surface roughness; (4) an average pore size of at least 0.35 microns; (5) an increased DB; (6) a TD tensile strength above 110 kg/cm²; (7) a lower ply to ply adhesion force; (8) a polypropylene blend including 10% to 100% by weight high crystallinity polypropylene; (9) a reduced surface area; and/or (10) a porosity of less than 40%.

In another aspect, object or embodiment, a battery separator for use in energy storage devices such as primary batteries, secondary batteries, or fuel cells is described herein. The battery separator may comprise at least one microporous membrane. The microporous membrane may be a microporous membrane, separator membrane, battery separator, or base film comprising a microporous membrane, wherein the microporous membrane has a thickness from 1 microns to 50 microns, 2 microns to 25 microns, 4 microns to 12 microns, or 5 microns to 10 microns, and exhibits one or more, two or more, three or more, four or more, five or more, or all of the following properties: (1) a puncture strength of 270 gf or more; (2) an MD tensile strength above 2,200 kg/cm²; (3) an increased surface roughness; (4) an average pore size of at least 0.35 microns; (5) an increased DB; (6) a TD tensile strength above 110 kg/cm²; (7) a lower ply to ply adhesion force; (8) a polypropylene blend including 10% to 100% by weight high crystallinity polypropylene; (9) a reduced surface area; and/or (10) a porosity of less than 35%.

The microporous membrane, separator membrane, battery separator, or base film above, wherein the microporous membrane has an MD tensile strength above 2,300 kg/cm², above 2,320 kg/cm², or above 2,340 kg/cm².

The microporous membrane, separator membrane, battery separator, or base film above, wherein the microporous membrane has a porosity below 40% or below 35%.

The microporous membrane, separator membrane, battery separator, or base film above, wherein the microporous membrane is a dry process polyolefin membrane and has a thickness from 5 microns to 10 microns; a puncture strength of 270 gf or more; an MD tensile strength above 2,200 kg/cm²; an increased surface roughness; an average pore size of at least 0.40 microns; an increased DB; a TD tensile strength above 130 kg/cm²; a lower ply to ply adhesion force; a polypropylene blend including 10% to 100% by weight high crystallinity polypropylene; (9) a reduced surface area; and/or (10) a porosity of less than 35% or 45%.

The microporous membrane, separator membrane, battery separator, or base film above, wherein the microporous membrane has one or more layers or plies.

The microporous membrane, separator membrane, battery separator, or base film above, wherein the microporous membrane has at least one outer surface, layer or ply made of a polypropylene blend including up to 100% by weight high crystallinity polypropylene.

The microporous membrane, separator membrane, battery separator, or base film above, wherein the microporous membrane is a dry-process microporous membrane.

The microporous membrane, separator membrane, battery separator, or base film above, wherein the microporous membrane has a melt point above 165° C.

The microporous membrane, separator membrane, battery separator, or base film above, wherein the microporous membrane is coated on one or two sides thereof.

An energy storage device comprising the microporous membrane, separator membrane, battery separator, or base film above, wherein the energy storage device is a primary battery, a secondary battery, or a fuel cell.

In yet another aspect, object or embodiment, a dry process polyolefin microporous membrane has a thickness from 4 microns to 12 microns, and exhibits one or more of the properties: (1) a puncture strength of 290 gf or more; (2) an MD tensile strength above 2,200 kg/cm²; (3) an increased surface roughness; (4) an average pore size of at least 0.35 microns; (5) an increased DB; (6) a TD tensile strength above 110 kg/cm²; (7) a lower ply to ply adhesion force; (8) a polypropylene blend including up to 100% by weight high crystallinity polypropylene; (9) a reduced surface area; and/or (10) a porosity of less than 40%.

In still yet another aspect, object or embodiment, a dry process polypropylene microporous membrane has a thickness from 4 microns to 12 microns, and exhibits one or more of the properties: (1) a puncture strength of 280 gf or more; (2) an MD tensile strength above 2,200 kg/cm²; (3) an increased surface roughness; (4) an average pore size of at least 0.35 microns; (5) an increased DB; (6) a TD tensile strength above 110 kg/cm²; (7) a lower ply to ply adhesion force; (8) a polypropylene blend including up to 100% by weight high crystallinity polypropylene; (9) a reduced surface area; and/or (10) a porosity of less than 45%.

In another aspect, an improved strength membrane is described herein. The membrane has a thickness from 1 microns to 50 microns, 2 microns to 25 microns, 4 microns to 12 microns, or 5 microns to 10 microns and exhibits one or more, two or more, three or more, four or more, five or more, or all of the following properties: (1) a puncture strength of 270 gf or more; (2) an MD tensile strength above 2,200 kg/cm²; (3) an increased surface roughness; (4) an average pore size of at least 0.35 microns; (5) an increased DB; (6) a TD tensile strength above 110 kg/cm²; (7) a lower ply to ply adhesion force; (8) a polypropylene blend including 10% to 100% by weight high crystallinity polypropylene; (9) a reduced surface area; (10) a durable puncture strength over time; and/or (11) a porosity of less than 40%.

An improved strength microporous membrane is described herein. The microporous membrane may be useful as a battery separator, separator membrane, base film, or membrane with a variety of related methods and uses thereof. The improved microporous membranes described herein may be dry process polyolefin membranes and may be used as battery separators or as a component of a composite or battery separator. The battery separators or composites may be used in energy storage devices including primary batteries, secondary batteries, fuel cells, capacitors, or super capacitors.

In some embodiments, the puncture strength of the microporous membrane may be 270 gf or more, 280 gf or more, 290 gf or more, 300 gf or more, or 310 gf or more.

In some embodiments, the microporous membrane may have an MD tensile strength above 2,000 kg/cm², above 2,100 kg/cm², above 2,200 kg/cm², above 2,300 kg/cm², or above 2,340 kg/cm².

In some embodiments, the microporous membrane is a dry-process microporous membrane.

In some embodiments, the microporous membrane is a microporous membrane having a melting point above 165° C.

In some embodiments, the microporous membrane is coated on one or two sides thereof.

In another aspect, an energy storage device comprising the battery separator described herein is described. The energy storage device may be a primary battery, a secondary battery, a fuel cell, a capacitor, or a super capacitor.

An improved strength microporous membrane is described herein. The microporous membrane may be useful as a battery separator, separator membrane, base film, or membrane with a variety of uses thereof. The improved microporous membranes described herein may be dry process polyolefin membranes and may be used as battery separators or as a component of a composite or battery separator. The battery separators or composites may be used in energy storage devices including primary batteries, secondary batteries, fuel cells, capacitors, or super capacitors.

In some embodiments, the puncture strength of the microporous membrane may be 270 gf or more, 280 gf or more, or 290 gf or more. Also, the puncture strength of the microporous membrane may be durable over time. For example, the puncture strength of the microporous membrane does not degrade appreciably over time. For instance, the puncture strength of the microporous membrane does not drop 5% over 3 months, 6 months, or 12 months.

In some embodiments, the microporous membrane may have an MD tensile strength above 2,000 kg/cm², above 2,100 kg/cm², above 2,200 kg/cm², above 2,300 kg/cm², or above 2,340 kg/cm².

In some embodiments, the microporous membrane is a dry-process microporous membrane. The dry process typically includes extrusion, annealing, cold stretch, hot stretch (MD or TD), and heat set. In the present description, the dry process may include multiple stretching steps or relax steps. The dry process membrane may have one or more layers or plies. The inventive improved strength membrane may be one or more layers of a multiple layer membrane structure.

In some embodiments, the microporous membrane is a microporous membrane having a melting point above 165° C. or 160° C.

In some embodiments, the microporous membrane is coated on one or two sides thereof.

In another aspect, an energy storage device comprising the battery separator described herein is described. The energy storage device may be a primary battery, a secondary battery, a fuel cell, a capacitor, or a super capacitor.

In preferred embodiments, the microporous membrane exhibits a puncture strength of 270 gf or more, 280 gf or more, or 290 gf or more.

In preferred embodiments, the microporous membrane exhibits a MD tensile strength above 2,290 kg/cm².

In preferred embodiments, the microporous membrane exhibits a porosity of less than 45%, of less than 40%, or of less than 35%.

In some preferred embodiments, the microporous membrane is a dry process microporous membrane. As understood in the art, a dry process membrane is a membrane made without the use of solvents or oils. As understood in the art, scanning electron micrographs (SEMs) of dry process membranes look distinctly different than those of wet process membranes, which are made using solvents and oils. See P. Arora and Z. Zhang, Battery Separators, Chem. Rev. 2004, 104, 4419-4462.

In some preferred embodiments, the microporous membrane may be formed using a cast or bubble extrusion process.

The microporous membranes described herein may have an average pore size of 1 micron or less, 0.9 microns or less, 0.8 microns or less, 0.7 microns or less, 0.6 microns or less, 0.5 microns or less, 0.4 microns or less, or 0.35 microns or less.

The composition of the microporous membrane is not so limited, but the microporous membranes described herein preferably comprise, consist of, or consist essentially of one or more polypropylene layers. In some preferred embodiments, the microporous membranes described herein comprise, consist of, or consist essentially of polypropylene homo-polymers or co-polymers. In some embodiments, the microporous membrane or at least its outer surface, layer or ply may comprise, consist of, or consist essentially of both high crystallinity polypropylene and typical polypropylene (homo-polymers, co-polymers, etc.) Preferably, the melt temperature of the microporous membrane is >160° C. or >165° C. The melt temperature of the membrane is dependent, at least in part, of the composition of the film or its layers.

### Battery Separator

In some embodiments, a battery separator may comprise, consist of, or consist essentially of a microporous membrane as described herein. In some embodiments, the battery separator may comprise, consist of, or consist essentially of a microporous membrane as described herein and at least one other microporous membrane.

In some embodiments, one or two sides of the microporous membrane may be coated. The coatings may be continuous or discontinuous. The coating may have a thickness from 0.5 to 5 microns, from 0.5 to 4 microns, from 0.5 to 3 microns, from 0.5 to 2 microns, or from 0.5 to 1 micron. For two-side coated embodiments, the coatings on each side may be the same or different.

The coating is not so limited and may be a ceramic coating, a sticky or adhesive coating, a shutdown coating, or the like. In some embodiments, the coating may comprise two or more layers. For example, the coating may comprise a ceramic layer with an adhesive layer provided on top of the ceramic layer. The adhesive layer may be continuous or discontinuous.

### Energy Storage Device

An energy storage device that comprises, consists of, or consists essentially of a battery separator as described herein is disclosed. The energy storage device may be a primary battery, a secondary battery, a fuel cell, a capacitor, or a super capacitor. Examples of secondary batteries may include Li-ion batteries, Na-ion batteries, flow batteries, and the like.

These energy storage devices may be used in electric vehicles (EVs), battery electric vehicles (BEVs), hybrid electric vehicles (HEVs), or plug-in hybrid electric vehicles (PHEVs).

### EXAMPLES

Three dry process stretched polypropylene (PP) membrane examples:
1. Typical PP membrane: 260 gf puncture strength; Inventive PP membrane: 290 gf puncture strength.
2. Inventive PP membrane had a higher puncture strength than the Typical PP membrane.
3. Typical PP membrane: 240 gf puncture strength; Inventive PP membrane: 290 gf puncture strength.

Many different arrangements of the various components and/or steps depicted and described, as well as those not shown, are possible without departing from the scope of the claims below. Embodiments of the present technology have been described with the intent to be illustrative rather than restrictive. Alternative embodiments will become apparent from reference to this disclosure. Alternative means of implementing the aforementioned can be completed without departing from the scope of the claims below. Certain features and subcombinations are of utility and can be employed without reference to other features and sub-combinations and are contemplated within the scope of the claims.

1. A microporous membrane, separator membrane, battery separator, or base film comprising a microporous membrane,
wherein the microporous membrane has a thickness from 1 microns to 50 microns, 2 microns to 25 microns, 4 microns to 12 microns, or 5 microns to 10 microns, and exhibits one or more, two or more, three or more, four or more, five or more, or all of the following properties: (1) a puncture strength of 270 gf or more; (2) an MD tensile strength above 2,200 kg/cm²; (3) an increased surface roughness; (4) an average pore size of at least 0.35 microns; (5) an increased DB; (6) a TD tensile strength above 110 kg/cm²; (7) a lower ply to ply adhesion force; (8) a polypropylene blend including 10% to 100% by weight higher crystallinity polypropylene; (9) a reduced surface area; and/or (10) a porosity of less than 45%.

2. The microporous membrane, separator membrane, battery separator, or base film of claim 1, wherein the microporous membrane has an MD tensile strength above 2,300 kg/cm², above 2,320 kg/cm², or above 2,340 kg/cm².

3. The microporous membrane, separator membrane, battery separator, or base film of claim 1, wherein the microporous membrane has a porosity less than 35%, less than 40%, or less than 45%.

4. The microporous membrane, separator membrane, battery separator, or base film of claim 1, wherein the microporous membrane is a dry process polyolefin membrane and has a thickness from 5 microns to 10 microns; a puncture strength of 290 gf or more; an MD tensile strength above 2,200 kg/cm²; an increased surface roughness; an average pore size of at least 0.40 microns; an increased DB; a TD tensile strength above 130 kg/cm²; a lower ply to ply adhesion force; a polypropylene blend including up to 100% by weight high crystallinity polypropylene; a reduced surface area; and/or a porosity less than 40%.

5. The microporous membrane, separator membrane, battery separator, or base film of claim 1, wherein the microporous membrane has one or more layers or plies.

6. The microporous membrane, separator membrane, battery separator, or base film of claim 1, wherein the microporous membrane has at least one outer surface, layer or ply made of a polypropylene blend including 10% to 100% by weight high crystallinity polypropylene.

7. The microporous membrane, separator membrane, battery separator, or base film of claim 1, wherein the microporous membrane is a dry-process microporous membrane.

8. The microporous membrane, separator membrane, battery separator, or base film of claim 1, wherein the microporous membrane has a melt point above 160° C.

9. The microporous membrane, separator membrane, battery separator, or base film of claim 1, wherein the microporous membrane is coated on one or two sides thereof.

10. An energy storage device comprising the microporous membrane, separator membrane, battery separator, or base film of claim 1, wherein the energy storage device is a primary battery, a secondary battery, or a fuel cell.

11. A dry process polyolefin microporous membrane having a thickness from 4 microns to 12 microns, and exhibiting one or more of the properties: (1) a puncture strength of 280 gf or more; (2) an MD tensile strength above 2,200 kg/cm²; (3) an increased surface roughness; (4) an average pore size of at least 0.35 microns; (5) an increased DB; (6) a TD tensile strength above 110 kg/cm²; (7) a lower ply to ply adhesion force; (8) a polypropylene blend including up to 100% by weight high crystallinity polypropylene; (9) a reduced surface area; and/or (10) a porosity of less than 45%.

12. A dry process polypropylene microporous membrane having a thickness from 4 microns to 12 microns, and exhibiting one or more of the properties: (1) a puncture strength of 270 gf or more; (2) an MD tensile strength above 2,200 kg/cm²; (3) an increased surface roughness; (4) an average pore size of at least 0.35 microns; (5) an increased DB; (6) a TD tensile strength above 110 kg/cm²; (7) a lower ply to ply adhesion force; (8) a polypropylene blend including up to 100% by weight long high crystallinity polypropylene; (9) a reduced surface area; and/or (10) a porosity of less than 40%.

13. The microporous membrane, separator membrane, battery separator, or base film of claim 1, wherein the microporous membrane has a puncture strength of 280 gf or more, 290 gf or more, 300 gf or more, or 310 gf or more.

14. The microporous membrane, separator membrane, battery separator, or base film of claim 1, wherein the microporous membrane has an MD tensile strength above 2,300 kg/cm², or above 2,340 kg/cm².

15. The microporous membrane, separator membrane, battery separator, or base film of claim 1, wherein the microporous membrane comprises, consists of, or consists essentially of one 10 or more polypropylene layers, of polypropylene homo-polymers or co-polymers, of at least an outer surface, layer or ply of both high crystallinity polypropylene and typical polypropylene (homo-polymers, co-polymers, etc.), or of combinations thereof.
